(19) United States
(12) Patent Application Publication
(10) Pub. No.: US 2024/0229430 A9
(43) Pub. Date: Jul. 11, 2024

(54) VALVE HEADPART FOR A SANITARY FAUCET AND SANITARY FAUCET WITH VALVE HEADPART

(71) Applicant: Grohe AG, Hemer (DE)

(72) Inventors: Bernd BISCHOFF, Hagen (DE); Stefan STEINHOFF, Sundern (DE)

(73) Assignee: Grohe AG, Hemer (DE)

(21) Appl. No.: 18/279,776

(22) PCT Filed: Mar. 3, 2022
(86) PCT No.: PCT/EP2022/055437

§ 371 Date: Sep. 21, 2023

(30) Foreign Application Priority Data
Mar. 4, 2021 (DE) 102021105194.0

(51) Int. Cl. E03C 1/04; F16K 1/36; F16K 1/46; F16K 31/50

(52) U.S. Cl. CPC E03C 1/04; F16K 1/36; F16K 1/46; F16K 31/508

(57) ABSTRACT

A valve headpart (1) for a sanitary faucet (2), containing at least: a body (3), a valve stem (4), which is at least partially disposed in the body (3) and can be rotated relative to the body (3) about an axis of rotation (5), a seal (6) for at least partially closing a valve seat (7) of the sanitary faucet (2), wherein the seal (6) can be adjusted by the valve stem (4) parallel to the axis of rotation (5) between an open position and a closed position, wherein the seal (6) has a first sealing element (8) made of a first material and a second sealing element (9) made of a second material, and wherein a first hardness of the first material is lower than a second hardness of the second material. Moreover, a sanitary faucet (2) having such a valve headpart (1) is proposed.

This invention relates to a valve headpart for controlling a flow of a liquid through a liquid duct of the sanitary faucet. Sanitary faucets can be used as shut-off faucets, in particular for shutting off the liquid duct, or as an outlet faucet, in particular for providing a liquid as required at a sink, wash basin, shower and/or bathtub.

Valve headparts regularly have a seal that is pressed against a valve seat of the sanitary faucet in a closed position of the seal and is compressed in the process. Frequent opening and closing of the valve headparts, which occurs particularly often and/or over a very long period in the case of sanitary valves, can therefore result in wear and ultimately in the failure of the seal.

Therefore, the invention addresses the problem of solving at least part of the problems described with reference to the prior art and, in particular, of providing a valve headpart, whose seal is subject to less wear. Moreover, a sanitary faucet having a valve headpart whose seal is subject to less wear, is to be disclosed.

These problems are solved by a valve headpart and a sanitary faucet having the features of the independent claims. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A valve headpart for a sanitary faucet, having at least the features listed below, contributes to solving the problem:
a body,
a valve stem at least partially disposed in the body and rotatable relative to the body about an axis of rotation,
a seal for at least partially closing a valve seat of the sanitary faucet, wherein the seal can be adjusted between an open position and a closed position by the valve stem in parallel to the axis of rotation, wherein the seal comprises a first sealing element made of a first material and a second sealing element made of a second material, and wherein a first hardness of the first material is lower than a second hardness of the second material.

The valve headpart can be used in particular for a sanitary faucet. The sanitary faucet can be designed in the manner of a shut-off faucet, which can be used to shut off a liquid duct and/or a liquid line. Furthermore, the sanitary faucet can be designed in the manner of an outlet faucet. Outlet faucets are used in particular to supply liquids, such as in particular water, to sinks, washbasins, showers and/or bathtubs on demand. For this purpose, cold water at a cold-water temperature and hot water at a hot-water temperature can be routed to the sanitary faucet, which cold water and hot water can be mixed by the sanitary faucet to form a mixed water having a desired mixed-water temperature. The cold-water temperature is in particular at most 25° C. (Celsius), preferably 1° C. to 25° C., particularly preferably 5° C. to 20° C., and/or the hot-water temperature is in particular at most 90° C., preferably 25° C. to 90° C., particularly preferably 55° C. to 65° C. The mixed water can then be routed, for instance by means of least one liquid line and/or by means of at least one liquid duct, to an outlet and/or an outlet opening of the sanitary faucet. The valve headpart can, for instance, be disposed at least partially in a faucet body of the sanitary faucet.

For this purpose, the valve headpart has a body and a valve stem that can be rotated relative to the body about an axis of rotation. The body can be made at least partially of plastic and/or metal, such as brass. The valve stem is at least partially disposed in the body and/or a user can rotate it relative to the cartridge body by an actuating element, for instance in the manner of an actuating handle or actuating lever, about the axis of rotation. The valve headpart also comprises a seal for at least partially closing a valve seat of the sanitary faucet. The seal can be attached to a closure element of the valve headpart, which can be designed, for instance, in the manner of a lifting cone or valve cone. The closure element can be made at least partially of plastic and/or metal, such as brass. The valve stem can be used to adjust the seal or the closure element having the seal between an open position and a closed position. In the open position, the valve seat is at least partially open and in the closed position it is closed, i.e., (substantially) no liquid can flow through the valve seat. The valve stem can adjust the seal and/or the closure element between the open position and the closed position, in particular in parallel to the axis of rotation.

The seal comprises a first sealing element made of a first material and a second sealing element made of a second material, wherein a first hardness of the first material is lower than a second hardness of the second material.

In particular, the sealing elements are in particular separate components, possibly matching joined components. In the assembled state, some of the sealing elements can be in direct contact with each other, i.e., in particular they can have matching contact surfaces (on the end face and/or circumferentially). It is also possible that one sealing element at least partially (detachably and/or displaceably) accommodates the other sealing element. In the assembled state, the sealing elements can form a connection in a form-fitting and/or force-locked manner. A form fit is created by blocking the relative motion of the sealing elements by structural form elements at at least one of the sealing elements such that a relative motion in one or more directions is blocked. A force-locked connection generates a normal force on the surfaces of the sealing elements to be connected, such that their mutual displacement is prevented as long as the counterforce caused by static friction is not exceeded.

For instance, the first sealing element may be at least partially made of an elastomer or rubber. For instance, the second sealing element may be made of a metal, such as brass, and/or a plastic, such as polytetrafluoroethylene (PTFE). Furthermore, the first hardness of the first material at a temperature of 23° C. (Celsius), for instance, may be at most 90 Shore-A, preferably 50 to 90 Shore-A, and/or the second hardness of the second material at a temperature of 23° C. (Celsius) may be above 90 Shore-A, preferably >90 to 100 Shore-A.

In the closed position of the seal, the second sealing element at least partially establishes a sealing contact between the seal and the valve seat or a sealing surface between the seal and the valve seat. Because the second hardness of the second material of the second sealing element is greater than the first hardness of the first material of the first sealing element, the wear of the seal can be reduced, wherein at the same time the first sealing element ensures sufficient elasticity or deformability of the seal. For this purpose, the first sealing element can be used as a spring element and/or as a spring-back aid for the second spring element. Furthermore, in the closed position of the seal, the second sealing element can prevent excessive deformation of the first sealing element and/or prevent the first sealing element from being pressed out of a mount of the seal, whereby cracks in the seal can be prevented.

The first sealing element and/or the second sealing element can be annular.

The first sealing element may have a first outer diameter that is greater than a second outer diameter of the second sealing element. The first outer diameter may be, for instance, 15 mm (millimeters) to 30 mm, preferably (approximately) 17 mm. The second outer diameter may be, for example, 12 mm to 16 mm, preferably (approximately) 14 mm.

The first sealing element may be disposed on a circumferential surface of the second sealing element. In particular, the first sealing element is disposed on an outer circumferential surface of the second sealing element.

The second sealing element can be disposed in a groove of the first sealing element. For instance, the groove may be formed on an end face/or a peripheral surface of the first sealing element.

The second sealing element may comprise at least one ventilation duct. In particular, a space between the first sealing element and the closure element can be ventilated by the ventilation duct, i.e., no vacuum can be generated in this space. The at least one ventilation duct may extend at least partially in parallel to the axis of rotation through the second sealing element.

In accordance with another aspect, a sanitary faucet is also proposed, comprising at least the components listed below:
a faucet body, in which a valve seat is disposed; and
a valve headpart proposed herein for at least partially closing the valve seat.

The faucet body can be made at least partially of plastic and/or metal, such as brass. Further, the faucet body may comprise at least one liquid inlet and/or at least one liquid outlet for the liquid. Furthermore, the faucet body may comprise a valve opening for the valve headpart. In particular, the valve headpart can be screwed into the valve opening. In addition, the faucet body and the valve seat can be integrally formed.

During a closing motion of a seal of the valve headpart, a first sealing element of the seal may contact an upper sealing seat surface of the valve seat before a second sealing element of the seal contacts a bevel of the sealing seat. This can also mean, among other things, that the seal first contacts the valve seat having the first sealing element on the upper sealing seat surface during the closing motion and only after a further motion of the seal in the direction of the closed position does the seal (also) contact the (outer and/or inner) bevel of the valve seat having the second sealing element. In addition, this can also mean in particular that in the closed position the first sealing element of the seal contacts the upper sealing seat surface of the valve seat and the second sealing element contacts the (outer and/or inner) bevel of the valve seat. Furthermore, this can also mean in particular that in the closed position the first sealing element of the seal does not contact the (outer/or inner) bevel of the valve seat and/or the second sealing element does not contact the upper sealing seat surface of the valve seat. The closing motion is in particular a motion of the seal in the direction of the valve seat. In particular, the bevel is formed on an inner edge of the sealing seat. In particular, the upper seal seating surface may be an area of the valve seat closest to the seal of the headpart, in particular if the seal does not contact the valve seat. Furthermore, the upper sealing seat surface may be the area of the valve seat that the seal contacts first during the closing motion. The upper sealing seat surface can, for instance, be designed in the manner of an upper sealing seat edge. Further, the upper sealing seat surface may be formed on an end face of the valve seat or a sleeve-shaped section of the valve seat. In addition, the upper sealing seat surface can be annular and/or (substantially) linear in shape.

The valve seat may have an outer bevel and an inner bevel. The outer bevel and inner bevel are formed in particular on the inner edge of the sealing seat. The outer bevel may be formed outside the inner bevel in a radial direction of the valve seat. The outer bevel may extend inwards from the top seal seat surface in the radial direction and/or the inner bevel may extend outwards from an inner surface of the valve seat in the radial direction. In addition, the outer bevel may have a first opening angle and/or the inner phase may have a second opening angle.

The first opening angle may be, for instance, 110° to 170°, preferably 148° to 152°, particularly preferably (approximately) 150°. The second opening angle may be, for instance, 60° to 90°, preferably 74° to 80°, particularly preferably (approximately) 77°.

During a closing motion of a seal of the valve headpart, a first sealing element of the seal may contact the outer bevel of the valve seat before a second sealing element of the seal contacts the inner bevel of the valve seat. This can also mean, among other things, that the first sealing element of the seal first contacts the valve seat at the outer bevel during the closing motion and only after a further motion of the seal in the direction of the closed position does the second sealing element of the seal (also) contact the inner bevel of the valve seat. In addition, this can also mean in particular that the first sealing element of the seal in the closed position contacts the outer bevel of the valve seat and the second sealing element contacts the inner bevel of the valve seat. Furthermore, this can also mean in particular that in the closed position, the first sealing element of the seal does not contact the inner bevel of the valve seat and/or the second sealing element does not contact the outer bevel of the valve seat.

For further details of the sanitary faucet, reference is made in full to the description of the valve headpart.

According to a further aspect, the use of a valve headpart proposed herein is proposed for low maintenance and low-wear sealing of lines and/or components of a sanitary faucet. The explanations on the valve headpart and/or the sanitary faucet can be used in full to specify this usage.

The invention and the technical environment are explained in more detail below with reference to the figures. It should be noted that the figures show particularly preferred embodiment variants of the invention, but the invention is not limited thereto. The same reference numerals are used for the same components in the figures. In an exemplary and schematic manner,

FIG. 1 shows a longitudinal section of a sanitary faucet having a first variant of a valve headpart;

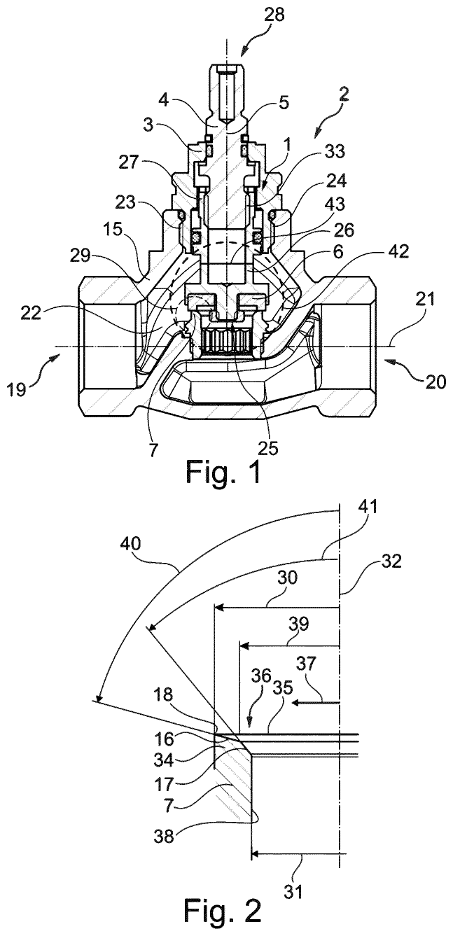

FIG. 2 shows a detailed view of a valve seat of the sanitary faucet;

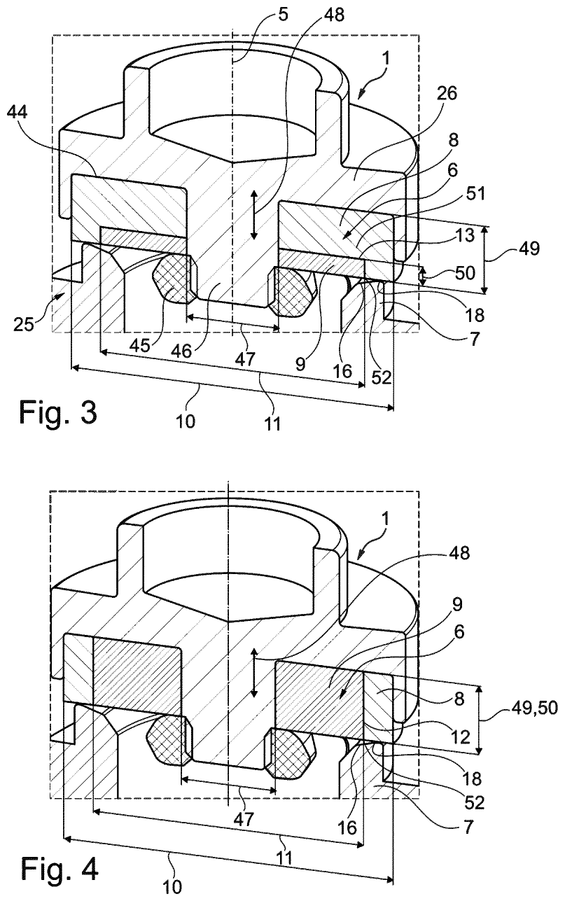

FIG. 3 shows a detailed view of a part of the first variant of the valve headpart;

FIG. 4 shows a detailed view of a part of a second variant of the valve headpart;

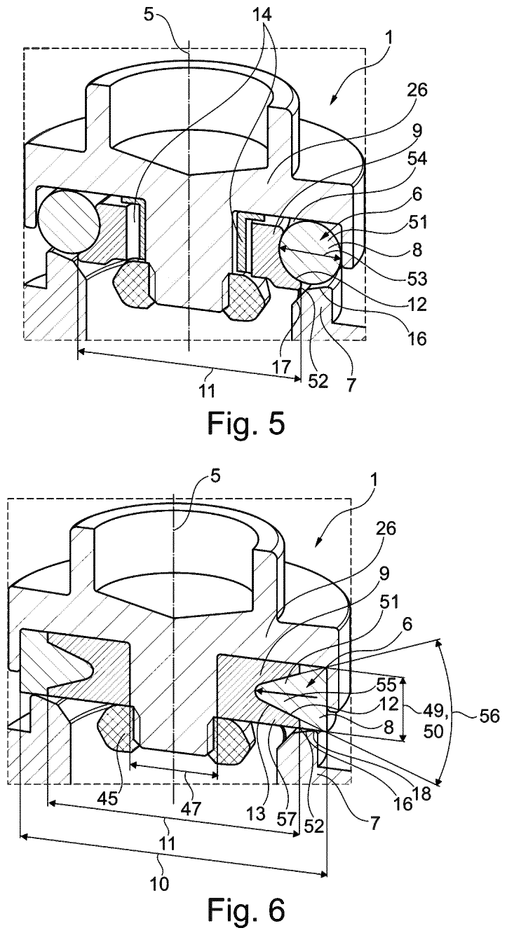

FIG. 5 shows a detailed view of a part of a third variant of the valve headpart;

FIG. 6 shows a detailed view of part of a fourth variant of the valve headpart; and

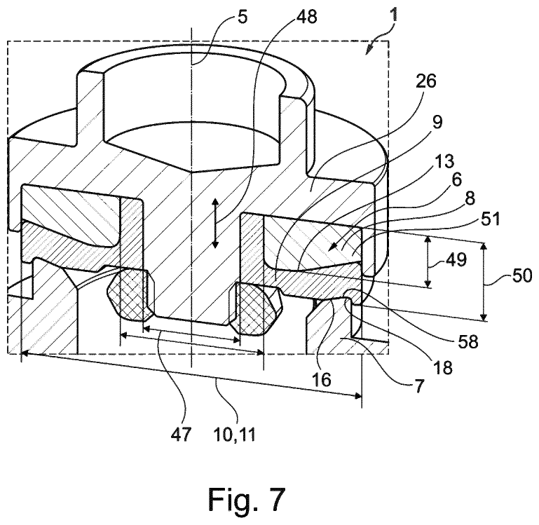

FIG. 7 shows a detailed view of a part of a fifth variant of the valve headpart.

FIG. 1 shows a longitudinal section of a sanitary faucet 2, which is designed in the manner of a shut-off valve in this case. The sanitary faucet 2 comprises a faucet body 15 having a liquid inlet and a liquid outlet 19. The liquid inlet 20 and the liquid outlet 19 are formed coaxially with each other and coaxially with a longitudinal axis 21 of the faucet body 15. A liquid inlet line not shown here can be connected to the liquid inlet 20, and a liquid outlet line not shown here can be connected to the liquid outlet line 19 (not shown here). For this purpose, the liquid inlet 20 and the liquid outlet 19 may each have a thread. The thread may be a ¾-inch female thread, for instance. The liquid inlet 20 is connected to the liquid outlet 19 via a liquid duct 22. A valve seat 7 for a seal 6 of a first variant of a valve headpart 1 is formed in the faucet body 15. To this end, the valve seat 7 is annular and extends in parallel to the longitudinal axis 21 of the valve body and coaxially to an axis of rotation 5 of a valve stem 4 of the valve headpart 1. The valve headpart 1 comprises a body 3, which is screwed into a valve opening 24 of the faucet body 15 via a first thread 23. The body 3 is designed in the manner of a head piece. The first thread 23 may be, for instance, a ⅜-inch thread, ½-inch thread, ¾-inch thread, or 1-inch thread. The valve opening 24 is coaxial with the axis of rotation 5 and orthogonal to the longitudinal axis 21 of the valve body 15. The seal 6 is disposed at a first longitudinal end 25 of a closure element 26 of the valve headpart 1 facing the seal seat 7. The closure element 26 has a tubular section 27 into which the valve stem 4 extends. The valve stem 4 is connected to the closure element 26 by a second thread 33. Because the valve stem 4 is firmly connected to the body 3 of the valve headpart 1 in parallel with the axis of rotation 5, the closure element 26 with the seal 6 can be adjusted between a closed position and an open position by rotating the valve stem 4 about the axis of rotation 5 in parallel to the axis of rotation 6. At a second longitudinal end 28, the valve stem 4 can be connected to an actuating element (not shown here), for instance in the manner of an actuating handle, which can be used to rotate the valve stem 4 about the axis of rotation by a user for opening and/or closing the sanitary faucet 2. In the closed position, the seal 6 is pressed against the valve seat 7 such that (essentially) no liquid can flow through the valve seat 7. In the open position, the seal 6 is lifted off the valve seat 7, allowing the liquid to flow through the valve seat 7.

FIG. 2 shows a detailed view of the first variant of the valve headpart 1 in an area marked by a first circle 29 in FIG. 1. The valve seat 7 comprises a sleeve-shaped section 34 that extends along a sealing seat axis 32 and toward the seal 6 shown in FIG. 1. The seal seat axis 32 extends coaxially with the axis of rotation 5 shown in FIG. 1. Furthermore, the valve seat 7 has an outer diameter of the valve seat 30 and an inner diameter of the valve seat 31. The outer diameter of the valve seat 30 can be, for instance, at least 15 mm, preferably 15 mm to 17 mm, particularly preferably (approximately) 16 mm. The inside diameter of the valve seat 31 can be, for instance, at most 12 mm, preferably 11 mm to 12 mm, particularly preferably (approximately) 11.5 mm. In addition, the sealing seat 7 has an upper sealing seat surface 18, which is an area of the valve seat 7 closest to the seal 6 of the valve headpart 1 shown in FIG. 1. The upper sealing seat surface 18 is formed there in the manner of an upper (annular) sealing seat edge. Furthermore, the upper sealing seat surface 18 is formed on an end surface 35 of the sleeve-shaped section 34 of the valve seat 7. The valve seat 7 has an outer bevel 16 and an inner bevel 17 on an inner edge 36. The outer bevel 16 is formed closer to the seal 6 of the valve headpart 1 shown in FIG. 1 than the inner seal 17. Furthermore, the outer bevel 16 is formed in a radial direction (to the sealing seat axis 32) 37 of the valve seat 7 outside the inner bevel 17. The outer bevel 16 extends inwards from the upper sealing seat surface 18 in the radial direction 37, and the inner bevel 17 extends outwards from an inner surface 38 of the valve seat 7 in the radial direction 37. The outer bevel 16 and the inner bevel 17 meet at an intermediate diameter 39 of the valve seat 7. Furthermore, the intermediate diameter 39 can be 12.5 mm to 13.5 mm, for instance, preferably (approximately) 13 mm. In addition, the outer bevel 16 has a first opening angle 40 and the inner bevel 17 has a second opening angle 41.

FIG. 3 shows a detailed view of a part of the first variant of the valve headpart 1 marked by a second circle 42 in FIG. 1. FIG. 3 only shows an area of the valve headpart 1 that is located below a sectional surface 43 shown in FIG. 1. The seal 6 is disposed at the first longitudinal end 25 of the closure element 26 in an annular mount 44 of the closure element 26, and is secured in the annular mount 44 by a fastener 45. The fastener 45 may be a nut, hex nut, bolt or flat head bolt. Furthermore, the fastening element 45 may be in the form of a pin protruding from the closure element 26. It may have an undercut that holds the seal 6 in position. The fastening element 45 is screwed onto a pin 46 of the closure element 26, which extends in parallel to the axis of rotation 5 in the direction of the valve seat 7. The seal 6 comprises a first sealing element 8 made of a first material and a second sealing element 9 made of a second material, wherein a first hardness of the first material is lower than a second hardness of the second material. The first sealing element 8 and second sealing element 9 are annular, wherein the second sealing element 9 is disposed in a groove 13 of the first sealing element 8. The first sealing element 8 has a first outer diameter 10 that is greater than a second outer diameter 11 of the second sealing element 9. Furthermore, the first sealing element 8 and the second sealing element 9 have an inner diameter 47. The inner diameter 47 can be, for instance, 3 mm to 10 mm, preferably 4 mm to 6 mm, particularly preferably (approximately) 5 mm. The first sealing element 8 extends in an axial direction 48, i.e., in parallel to the axis of rotation 5, having a first length 49 and the second sealing element 9 having a second length 50. The first length 49 may be, for instance, at least 2 mm, preferably 2 mm to 5 mm, particularly preferably (approximately) 3.5 mm. The second length 50 may be, for instance, at most 4 mm, preferably 0.5 mm to 3 mm, particularly preferably (approximately) 1 mm. Furthermore, the second sealing element 9 is designed here in the manner of a support disk. The first sealing element 8 and the second sealing element 9 are formed such that the seal 6 has a rectangular cross-sectional area 51. During a closing motion of the seal 6, i.e., during a motion of the seal 6 in the direction of a closed position and/or in the direction of the valve seat 7, the first sealing element 8 contacts the upper sealing seat surface 18 of the valve seat 7, such that a first sealing surface is formed between the first sealing element 8 and the upper sealing seat surface 18. During a further motion of the seal 6 in the direction of the closed position and/or in the direction of the valve seat 7, the first sealing element 8 is elastically deformed by the upper sealing seat surface 18 until the outer edge 52 of the second sealing element 9 of the seal 6 contacts the outer bevel 16 of the valve seat 7. To this end, a second sealing surface is formed between the second sealing element 9 and the outer bevel 16, which is initially linear and becomes planar as the seal 6 progresses toward its closed position, causing the seal 6 to close the valve seat 7. In so doing, the second sealing element 9 prevents any excessive deformation of the first sealing element 8 by the upper sealing surface 18, such that excessive stress on the first sealing element 8 is prevented. In particular, the second hardness of the second material of the second sealing element 9 permits an elastic deformation of the second sealing element 9 when the seal 6 is in the closed position.

FIG. 4 shows a detailed view of a second variant of the valve headpart 1 in the area marked by the second circle 42 in FIG. 1. The second variant of the valve headpart 1 differs from the first variant of the valve headpart 1 only by a differently formed seal 6. The seal 6 also comprises a first sealing element 8 made of a first material and a second sealing element 9 made of a second material, wherein a first hardness of the first material is lower than a second hardness of the second material. The first sealing element 8 and second sealing element 9 are annular in shape, wherein the first sealing element 8 is disposed on a circumferential surface 12 of the second sealing element 9. The first sealing element 8 can, for instance, be created from a cut-off hose seal or manufactured as an off-tool part. The first sealing element 8 has a first outer diameter 10 that is greater than a second outer diameter 11 of the second sealing element 9. Furthermore, the first sealing element 8 and the second sealing element 9 have an inner diameter 47. A first length 49 of the first sealing element 8 and a second length 50 of the second sealing element 9 extend in the axial direction 48, wherein the first length 49 and the second length 50 are identical in this case. The first length 49 and the second length 50 can be, for instance, at least 2 mm, preferably 2 mm to 5 mm, particularly preferably (approximately) 3.5 mm. The second sealing element 9 can be designed, for instance, as an off-tool part or as a turned part. Furthermore, the second sealing element 9 may be cut-off from a semi-finished tube. The first sealing element 8 and the second sealing element 9 are formed such that the seal 6 has a rectangular cross-sectional area 51. During a closing motion of the seal 6, i.e., during a motion of the seal 6 in the direction of a closed position and/or in the direction of the valve seat 7, the first sealing element 8 contacts the upper sealing seat surface 18 of the valve seat 7, such that a first sealing surface is formed between the first sealing element 8 and the upper sealing seat surface 18. During a further motion of the seal 6 in the direction of the closed position and/or in the direction of the valve seat 7, the first sealing element 8 is elastically deformed by the upper sealing seat surface 18 until the outer edge 52 of the second sealing element 9 of the seal 6 contacts the outer bevel 16 of the valve seat 7. To this end, a second sealing surface is formed between the second sealing element 9 and the outer bevel 16, which is initially linear and becomes planar as the seal 6 progresses toward its closed position, causing the seal 6 to close the valve seat 7. A main sealing contact between the valve seat 7 and the seal 6 can be established in particular by the second sealing surface between the second sealing element 9 and the outer bevel 16, wherein the sealing contact is supported by the first sealing surface between the first sealing element 8 and the upper sealing seat surface 18. In so doing, the second sealing element 9 prevents any excessive deformation of the first sealing element 8 by the upper sealing surface 18, such that excessive stress on the first sealing element 8 is prevented. In particular, the second hardness of the second material of the second sealing element 9 permits an elastic deformation of the second sealing element 9 when the seal 6 is in the closed position.

FIG. 5 shows a detailed view of a third variant of the valve headpart 1 in the area marked by the second circle 42 in FIG. 1. The third variant of the valve headpart 1 differs from the first and second variants of the valve headpart 1 only by a differently formed seal 6. The seal 6 comprises a first sealing element 8 made of a first material and a second sealing element 9 made of a second material, wherein a first hardness of the first material is lower than a second hardness of the second material. The first sealing element 8 and second sealing element 9 are annular in shape, wherein the first sealing element 8 is disposed on a circumferential surface 12 of the second sealing element 9. The first sealing element 8 is designed here in the form of an O-ring. A cross-sectional area 51 of the first sealing element 8 has a cross-sectional diameter 53. The cross-sectional diameter 53 may be, for instance, at least 1 mm, preferably 1 mm to 5 mm, particularly preferably (approximately) 3.5 mm. The second sealing element 9 is designed in the manner of a support ring, which holds the first sealing element 8 or prevents the first sealing element 8 from detaching from the closure element 26. The second sealing element 9 may, for instance, be designed as an off-tool part and have a second diameter 11. The second diameter 11 may be, for instance, 12 mm to 13 mm, preferably (approximately) 12.5 mm. During a closing motion of the seal 6, i.e., during a motion of the seal 6 in the direction of a closed position and/or in the direction of the valve seat 7, the first sealing element 8 contacts the outer bevel 16 of the valve seat 7, so that a first sealing surface is formed between the first sealing element 8 and the outer bevel 16. During a further motion of the seal 6 in the direction of the closed position and/or in the direction of the valve seat 7, the first sealing element 8 is elastically deformed by the outer bevel 16 until the outer edge 52 of the second sealing element 9 of the seal 6 contacts the inner bevel 17 of the valve seat 7. To this end, a second sealing surface is formed between the second sealing element 9 and the outer bevel 16, which is initially linear and becomes planar as the seal 6 progresses toward its closed position, causing the seal 6 to close the valve seat 7. A main sealing contact between the valve seat 7 and the seal 6 can be established in particular by the second sealing surface between the second sealing element 9 and the inner bevel 17, wherein the sealing contact is supported by the first sealing surface between the first sealing element 8 and the outer bevel 16. In this case, the second sealing element 9 prevents any excessive deformation of the first sealing element 8 by the outer bevel 16, such that excessive stress on the first sealing element 8 is prevented. In particular, the second hardness of the second material of the second sealing element 9 permits an elastic deformation of the second sealing element 9 when the seal 6 is in the closed position. The second sealing element 9 also has a plurality of ventilation ducts 14, via which a space 54 between the first sealing element 8 and the closure element 26 can be ventilated. This can prevent a vacuum from forming in the space 54. The ventilation ducts 14 extend completely through the second sealing element 9 in parallel to the axis of rotation 5.

FIG. 6 shows a detailed view of a fourth variant of the valve headpart 1 in the area marked by the second circle 42 in FIG. 1. The fourth variant of the valve headpart 1 differs from the first to third variants of the valve headpart 1 only by a differently formed seal 6. The seal 6 also comprises a first sealing element 8 made of a first material and a second sealing element 9 made of a second material, wherein a first hardness of the first material is lower than a second hardness of the second material. The first sealing element 8 and second sealing element 9 are annular in shape, wherein the first sealing element 8 is disposed on a circumferential surface 12 of the second sealing element 9. The first sealing element 8 has a first outer diameter 10 and the second sealing element 9 has a second outer diameter 11. In addition, the first sealing element 8 and the second sealing element 9 have an inner diameter 47. The inner diameter 47 can be, for instance, 3 mm to 10 mm, preferably 4 mm to 6 mm, particularly preferably (approximately) 5 mm. In addition, the first sealing element 8 has a first length 49 in parallel to the axis of rotation 5 and the second sealing element 9 has a second length 50 in parallel to the axis of rotation 5, wherein the first length 49 and the second length 50 are identical. The first length 49 and the second length 50 can be, for instance, at least 2 mm, preferably 2 mm to 5 mm, particularly preferably (approximately) 3.5 mm. The first sealing element 8 can, for instance, be manufactured as an off-tool part and/or has no undercuts. A cross-sectional area 51 of the first sealing element 8 has a V-shaped area 55 having a third opening angle 56. The opening angle 56 may be, for example, 20° to 150°, preferably 30° to 50°, particularly preferably (approximately) 40°. The second sealing element 9 has a matching V-shaped groove 13 on its circumferential surface 12, in which the first sealing element 8 is disposed. The first sealing element 8 is in particular buttoned onto the second sealing element 9. Thus, both the first sealing element 8 and the second sealing element 9 are connected captively to the closure element 26 via the fastening element 45. The second sealing element 9 can, for instance, be designed as an off-tool part and/or without undercuts. The first sealing element 8 and the second sealing element 9 are formed such that the seal 6 has a rectangular cross-sectional area 51. Furthermore, the first sealing element 8 and the second sealing element 9 are symmetrical, i.e., no special alignment is required when assembling the valve headpart 1. During a closing motion of the seal 6, i.e., during a motion of the seal 6 in the direction of a closed position and/or in the direction of the valve seat 7, the first sealing element 8 contacts the upper sealing seat surface 18 of the valve seat 7, such that a first sealing surface is formed between the first sealing element 8 and the upper sealing seat surface 18. During a further motion of the seal 6 in the direction of the closed position and/or in the direction of the valve seat 7, the first sealing element 8 is elastically deformed by the upper sealing seat surface 18 until the second sealing element 9 of the seal 6 contacts the outer bevel 16 of the valve seat 7 with its outer edge 52. To this end, a second sealing surface is formed between the second sealing element 9 and the outer bevel 16, which is initially linear and becomes planar as the seal 6 progresses toward its closed position, causing the seal 6 to close the valve seat 7. A main sealing contact between the valve seat 7 and the seal 6 can be established in particular by the second sealing surface between the second sealing element 9 and the outer bevel 16, wherein the sealing contact is supported by the first sealing surface between the first sealing element 8 and the upper sealing seat surface 18. In so doing, the second sealing element 9 prevents any excessive deformation of the first sealing element 8 by the upper sealing surface 18, such that excessive stress on the first sealing element 8 is prevented. In particular, the second hardness of the second material of the second sealing element 9 permits an elastic deformation of the second sealing element 9 when the seal 6 is in the closed position. In particular, a flank 57 of the groove 13 of the second sealing element 9 can be elastically deformed.

FIG. 7 shows a detailed view of a fifth variant of the valve headpart 1 in the area marked by the second circle 42 in FIG. 1. The fifth variant of the valve headpart 1 differs from the first to fourth variants of the valve headpart 1 only by a differently formed seal 6. The seal 6 comprises a first sealing element 8 made of a first material and a second sealing element 9 made of a second material, wherein a first hardness of the first material is lower than a second hardness of the second material. The first sealing element 8 and second sealing element 9 are annular, wherein the first sealing element 8 is disposed in a groove 13 of the second sealing element 9. The first sealing element 8 has a first outer diameter 10 and the second sealing element 9 has a second outer diameter 11, wherein the first outer diameter 10 and the second outer diameter 11 are identical. For instance, the first outer diameter 10 and the second outer diameter 10 may be at least 15 mm, preferably 15 mm to 19 mm, more preferably (approximately) 17 mm. Furthermore, the first sealing element 8 and the second sealing element 9 have an inner diameter 47. The inner diameter 47 can be, for instance, 3 mm to 10 mm, preferably 4 mm to 6 mm, particularly preferably (approximately) 5 mm. The first sealing element 8 extends in an axial direction 48, i.e. In parallel to the axis of rotation 5, having a first length 49 and the second sealing element 9 having a second length 50. The first length 49 may be, for instance, at least 2 mm, preferably 2 mm to 5 mm, particularly preferably (approximately) 2.5 mm. The second length 50 may be, for instance, at least 3 mm, preferably 3 mm to 5 mm, particularly preferably (approximately) 3.8 mm. In addition, the first sealing element 8 can be designed as an off-tool part and/or without undercuts. Furthermore, the second sealing element 9 is designed here in the manner of a cup washer. The second sealing element 9 can be designed as an off-tool part and/or without undercuts. The second sealing element 9 has an outer contour 58 that follows a contour of the outer bevel 16 of the valve seat 7 and an upper sealing seat surface 18 of the valve seat 7. As a result, there is no line contact between the second sealing element 9 and the valve seat 7 during a closing motion of the seal 6, resulting in a lower surface pressure. When the seal 6 moves further towards the closed position, the second sealing element 9 is deformed in such a way that the second sealing element 9 rolls on the upper sealing surface 18 of the valve seat 7, creating a line contact. The first sealing element 8 is disposed between the second sealing element 9 and the closure element 26 and, in the fifth variant of the valve headpart 1, is used in particular as a return spring or return spring aid for the second sealing element 9.

This invention can be used to reduce the wear of the seal.

### LIST OF REFERENCES

1 valve headpart
2 sanitary faucet
3 body
4 valve stem
5 axis of rotation
6 seal
7 valve seat
8 first sealing element
9 second sealing element
10 first outer diameter
11 second outer diameter
12 circumferential surface
13 groove
14 ventilation duct
15 faucet body
16 outer bevel
17 inner bevel
18 upper sealing surface
19 liquid outlet
20 liquid inlet
21 longitudinal axis of body
22 liquid duct
23 first thread
24 valve opening
25 first longitudinal end
26 closure element
27 tubular section
28 second longitudinal end
29 first circle
30 outer diameter of the valve seat
31 inner diameter of the valve seat
32 sealing seat axis
33 second thread
34 tubular section
35 end face
36 inner edge
37 radial direction
38 inner surface
39 intermediate diameter
40 first opening angle
41 second opening angle
42 second circle
43 sectional surface
44 mount
45 fastener
46 pin
47 inner diameter
48 axial direction
49 first length
50 second length
51 cross-sectional area
52 outer edge
53 cross-section diameter
54 space
55 V-shaped area
56 third opening angle
57 flank
58 outer contour

1. A valve headpart (1) for a sanitary faucet (2), comprising at least:
a body (3),
a valve stem (4), which is at least partially disposed in the body (3) and can be rotated relative to the body (3) about an axis of rotation (5),
a seal (6) for at least partially closing a valve seat (7) of the sanitary faucet (2), wherein the seal (6) can be adjusted between an open position and a closed position by the valve stem (4) in parallel to the axis of rotation (5), wherein the seal (6) comprises a first sealing element (8) made of a first material and a second sealing element (9) made of a second material, and wherein a first hardness of the first material is lower than a second hardness of the second material.

2. The valve headpart (1) according to claim 1, wherein the first sealing element (8) or the second sealing element (9) is annular.

3. The valve headpart (1) according to claim 1, wherein the first sealing element (8) has a first outer diameter (10) that is greater than a second outer diameter (11) of the second sealing element (9).

4. The valve headpart (1) according to claim 1, wherein the first sealing element (8) is disposed on a circumferential surface (12) of the second sealing element (9).

5. The valve headpart (1) according to claim 1, wherein the second sealing element (9) is disposed in a groove (13) of the first sealing element (8).

6. The valve headpart (1) according to claim 1, wherein second sealing element (9) has least one ventilation duct (14).

7. A sanitary faucet (2), comprising at least:
a faucet body (15), in which a valve seat (7) is disposed; and
a valve headpart (1) according to claim 1, at least partially closing the valve seat (7).

8. The sanitary faucet (2) according to claim 7, wherein during a closing motion of a seal (6) of the valve headpart (1), a first sealing element (8) of the seal (6) contacts an upper sealing seat surface (18) of the valve seat (7) before a second sealing element (9) of the seal (6) contacts a bevel (16, 17) of the valve seat (7).

9. The sanitary faucet (2) according to claim 7, wherein the valve seat (7) comprises an outer bevel (16) and an inner bevel (17).

10. The sanitary faucet (2) according to claim 9, wherein during a closing motion of a seal (6) of the valve headpart (1), a first sealing element (8) of the seal (6) contacts the outer bevel (16) of the valve seat (7) before a second sealing element (9) of the seal (6) contacts the inner bevel (17) of the valve seat (7).
